(19) United States
(12) Patent Application Publication
(10) Pub. No.: US 2017/0357486 A1
(43) Pub. Date: Dec. 14, 2017

(54) ENHANCING A CROWDSOURCED INTEGRATED DEVELOPMENT ENVIRONMENT APPLICATION

(71) Applicant: International Business Machines Corporation, Armonk, NY (US)

(72) Inventors: Lisa Seacat DeLuca, Baltimore, MD (US); Dana L. Price, Surf City, NC (US); Aaron J. Quirk, Cary, NC (US); Shelbee D. Smith-Eigenbrode, Thornton, CO (US)

(21) Appl. No.: 15/179,131

(22) Filed: Jun. 10, 2016

(51) Int. Cl. G06F 9/44

(52) U.S. Cl. CPC G06F 8/30

(57) ABSTRACT

A method and associated systems for enhancing a crowdsourced integrated development environment (IDE). A computerized component of the IDE receives a block of annotated source code from a user who seeks to solve a software problem embodied by the source code. The annotations direct the IDE to solicit help from external online user communities identified by the notations. The annotations also describe the software problem and provide further instructions for creating an anonymized distribution bundle that includes the source code, the text description, any related blocks of source code, and contextual information required to address the problem. In response to receiving the solicitation and distribution bundle, and interested users of the online communities respond with feedback. The IDE receives and analyzes the feedback and displays it to the user so as to identify responses that have a higher likelihood of solving the software problem.

### TECHNICAL FIELD

The present invention relates to improving the operation of an integrated development environment application that permits crowdsourced software development.

### BACKGROUND

An integrated development environment (IDE) may allow a software developer to more efficiently write code by providing a customized interface that is seamlessly integrated with tools like automatic code generators, deduplication functions, collaboration features, and package-management aids.

Such a computerized development environment cannot, however, resolve many types of coding problems. A software design that requires a specific type of data structure or forces a developer to choose between nonstandard coding techniques may require expert knowledge that is beyond the capability of an IDE user.

One solution is to enhance an IDE by allowing it to request advice from remote users, such as users of an online social-media community. Such a collaborative enhancement may allow the IDE to support a crowdsourcing feature by which a developer, using tools available from within the IDE environment, can request and receive advice from remote users via the Internet, cellular networks, or a cloud-computing platform.

Such an IDE, however, must overcome technical problems that do not exist in a nonintegrated development environment or in an integrated development environment that does not offer such crowdsourcing functionality. Because making source code available to anonymous users of remote or online social platforms may raise security and privacy concerns, a method must be devised that anonymizes or partially conceals identifying characteristics of the requesting IDE user, that user's employer, or the intended use of problematic source code. IDE applications available today do not offer such functionality.

Another problem that must be addressed by such an enhanced IDE is that crowdsourcing functionality may not seamlessly integrated into the IDE's development environment. One of an IDE's greatest strengths is that it conforms to interface conventions that make it easy to use and that allow a user to access and use integrated tools by means of consistent command structures and methods. It may not be possible to cleanly integrate a crowdsourcing feature into an IDE application that was never intended to facilitate such distributed, collaborative operation without straying from some of the interface conventions from which the IDE derives its ease of use.

In particular, such an enhanced IDE must be able to identify, access, anonymize, compartmentalize, mark up, and communicate code fragments created by a user in a manner that is consistent with other operations that may be performed within the integrated development environment. A solution that works only with a specially designed IDE application is not useful to the many developers who have already committed the time and expense to gain facility working within an existing IDE platform.

Finally, such an enhanced IDE should be able to interoperate with a flexible selection of external user communities, such as popular social-media services and technically oriented online-developer networks. Depending on user requirements, the IDE should be configurable to transparently communicate with popular public platforms like Twitter and Facebook, with technically oriented crowdsourcing or social-media services, or with internal or privately owned systems. An ideal solution would be flexible enough to be configured to work with any subset of candidate online communities and to integrate seamlessly into existing IDE applications.

Such a technical solution to these technical problems does not exist and even the most advanced IDEs, which may already offer some form of remote-collaboration functionality, do not address all these challenges. There is thus a need for a method of enhancing an existing IDE to allow a user to request help from unidentified users of a user-selectable set of external online communities, and to do so without sacrificing the IDE's advantages of ease-of-use, interface consistency, or intrinsic guarantees of security and privacy.

### BRIEF SUMMARY

A first embodiment of the present invention provides a method for enhancing a crowdsourced integrated development environment (IDE) system, and provides a technical advantage of allowing IDE users, without forcing them to deviate from familiar interface conventions, to anonymously collaborate and share source code with remote users of online communities and social networks. The method begins with the enhanced IDE system retrieving annotations from a block of computer source code created by an IDE user to identify a software-design problem. The system captures related information, identified by the annotations, that provides context to the source code and then bundles the code and context into a distribution package. The system next solicits feedback from one or more online communities identified by the annotations and communicates the distribution package to online users who indicate interest in solving the problem. The system accepts feedback responses from these interested online users, ranks each feedback response in order of its likelihood of solving the software-design problem, and forwards the resulting ranked feedback list to the user.

A second embodiment of the present invention provides an enhanced interactive development (IDE) system that includes a processor, a memory coupled to the processor, and a computer-readable hardware storage device coupled to the processor. The storage device contains program code configured to be run by enhanced IDE system to implement a method for enhancing a crowdsourced integrated development environment system, and provides a technical advantage of allowing IDE users, without forcing them to deviate from familiar interface conventions, to anonymously collaborate and share source code with remote users of online communities and social networks. The method begins with the enhanced IDE system retrieving annotations from a block of computer source code created by an IDE user to identify a software-design problem. The system captures related information, identified by the annotations, that provides context to the source code and then bundles the code and context into a distribution package. The system next solicits feedback from one or more online communities identified by the annotations and communicates the distribution package to online users who indicate interest in solving the problem. The system accepts feedback responses from these interested online users, ranks each feedback response in order of its likelihood of solving the software-design problem, and forwards the resulting ranked feedback list to the user

A third embodiment of the present invention provides a computer program product that includes a computer-readable hardware storage device containing computer-readable program configured to be run by an enhanced integrated development environment (IDE) system to implement a method for method for enhancing a crowdsourced integrated development environment (IDE) system, and provides a technical advantage of allowing IDE users, without forcing them to deviate from familiar interface conventions, to anonymously collaborate and share source code with remote users of online communities and social networks. The method begins with the enhanced IDE system retrieving annotations from a block of computer source code created by an IDE user to identify a software-design problem. The system captures related information, identified by the annotations, that provides context to the source code and then bundles the code and context into a distribution package. The system next solicits feedback from one or more online communities identified by the annotations and communicates the distribution package to online users who indicate interest in solving the problem. The system accepts feedback responses from these interested online users, ranks each feedback response in order of its likelihood of solving the software-design problem, and forwards the resulting ranked feedback list to the user.

### BRIEF DESCRIPTION OF THE DRAWINGS

FIG. 1 shows the structure of a computer system and computer program code that may be used to implement a method for enhancing a crowdsourced integrated development environment in accordance with embodiments of the present invention.

FIG. 2 is a flow chart that illustrates the steps of a method for enhancing a crowdsourced integrated development environment in accordance with embodiments of the present invention.

### DETAILED DESCRIPTION

Online communities, which may include online technical communities, professional organizations, or social-media services, provide a powerful way for users to share information and collaborate with peers. This capability can be especially valuable to a software developer, even if the developer normally works alone within a self-contained programming environment provided by an integrated development environment (“IDE”) application.

While some IDEs have been enhanced to support basic collaboration functions, these functions may be limited, and users of such an IDE may be able to collaborate with only a limited or predefined set of known collaborators or collaboration platforms. In some cases, such collaboration is possible only by means of a third-party application that does not necessarily conform to the consistent, seamless user-interface and tool conventions of the IDE, thus negating one of the IDE's main advantages. Furthermore, such IDEs may not adequately protect security or privacy of a user or of the source code being developed by the user. All of these technical problems are necessarily rooted in IDE technology and do not arise when a developer or designer seeks help from colleagues in a noncomputerized working environment.

Embodiments of the present invention, on the other hand, solve these technical problems by providing a novel way for a developer to transparently request help with a coding or design problem from within an existing, familiar IDE environment by sharing anonymized code with user-selected online communities.

In one example, an IDE user attempting to write source code that comprises an indexing operation might be faced with a context-dependent decision whether to organize data into a hashtable, a hashmap, a linked list, or an array list.

Embodiments of the present invention enable such a developer to use basic annotation features, similar to those already offered by the IDE, to embed novel social-code annotations into a block of source code that embodies the indexing-design problem. These annotations may identify a context of the problem, specify how to anonymize the code, direct a manner of sharing the code with remote users or online communities, or request feedback from remote users willing or qualified to help solve the problem.

Embodiments may further identify which of the remote users to accept feedback from or limit information made accessible to certain of the users, in order to further minimize security and privacy issues and to increase the probability that feedback is received from only authorized or technically qualified responding users.

Because many IDE platforms are extensible through standard mechanisms like third-party plug-in modules or drivers, embodiments of the present invention allow users to continue leveraging existing benefits of an IDE by using an IDE's existing extensibility features. A technical advantage of the present invention is thus that it does not require modifications to remote online-community platforms or to other software used to communicate with the remote users.

Embodiments thus allow users, by means of an existing IDE's familiar user interface, to solicit software-development aid from remote online communities or social-media networks, to selectively anonymize elements of code and contextual information of the code that are shared with the remote communities or networks, to choose whether to anonymize the soliciting or requesting IDE user, to specify which online communities, social-media networks, or individual remote users may be allowed to respond, to manage communications between the soliciting user and a responding user, or to organize received instances of feedback as functions of each instance's relevance or likelihood to be effective. In this way, the developer can consider suggestions made by a large number of responding users of external online communities, overcoming technical problems that would otherwise arise when attempting to add features to a single user's IDE that allow secure, privatized, and automated collaboration with unknown users of an external online community.

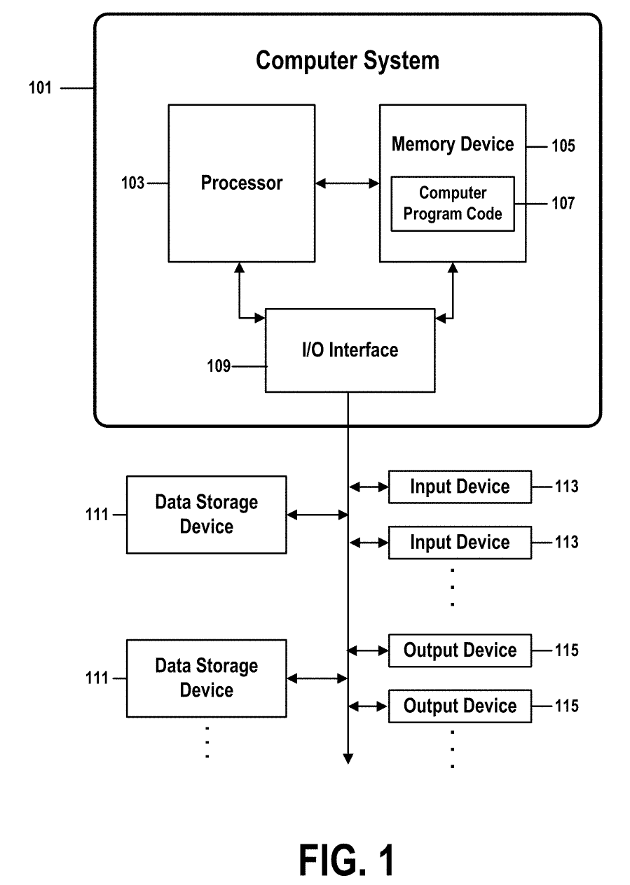

FIG. 1 shows a structure of a computer system and computer program code that may be used to implement a method for enhancing a crowdsourced integrated development environment in accordance with embodiments of the present invention. FIG. 1 refers to objects 101-115.

Aspects of the present invention may take the form of an entirely hardware embodiment, an entirely software embodiment (including firmware, resident software, microcode, etc.) or an embodiment combining software and hardware aspects that may all generally be referred to herein as a “circuit,” “module,” or “system.”

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

In FIG. 1, computer system 101 comprises a processor 103 coupled through one or more I/O Interfaces 109 to one or more hardware data storage devices 111 and one or more I/O devices 113 and 115.

Hardware data storage devices 111 may include, but are not limited to, magnetic tape drives, fixed or removable hard disks, optical discs, storage-equipped mobile devices, and solid-state random-access or read-only storage devices. I/O devices may comprise, but are not limited to: input devices 113, such as keyboards, scanners, handheld telecommunications devices, touch-sensitive displays, tablets, biometric readers, joysticks, trackballs, or computer mice; and output devices 115, which may comprise, but are not limited to printers, plotters, tablets, mobile telephones, displays, or sound-producing devices. Data storage devices 111, input devices 113, and output devices 115 may be located either locally or at remote sites from which they are connected to I/O Interface 109 through a network interface.

Processor 103 may also be connected to one or more memory devices 105, which may include, but are not limited to, Dynamic RAM (DRAM), Static RAM (SRAM), Programmable Read-Only Memory (PROM), Field-Programmable Gate Arrays (FPGA), Secure Digital memory cards, SIM cards, or other types of memory devices.

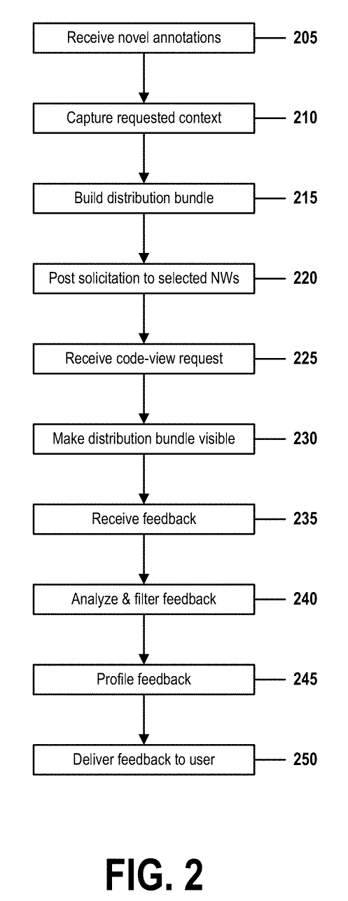

At least one memory device 105 contains stored computer program code 107, which is a computer program that comprises computer-executable instructions. The stored computer program code includes a program that implements a method for enhancing a crowdsourced integrated development environment in accordance with embodiments of the present invention, and may implement other embodiments described in this specification, including the methods illustrated in FIGS. 1-2. The data storage devices 111 may store the computer program code 107. Computer program code 107 stored in the storage devices 111 is configured to be executed by processor 103 via the memory devices 105. Processor 103 executes the stored computer program code 107.

In some embodiments, rather than being stored and accessed from a hard drive, optical disc or other writeable, rewriteable, or removable hardware data-storage device 111, stored computer program code 107 may be stored on a static, nonremovable, read-only storage medium such as a Read-Only Memory (ROM) device 105, or may be accessed by processor 103 directly from such a static, nonremovable, read-only medium 105. Similarly, in some embodiments, stored computer program code 107 may be stored as computer-readable firmware 105, or may be accessed by processor 103 directly from such firmware 105, rather than from a more dynamic or removable hardware data-storage device 111, such as a hard drive or optical disc.

Thus the present invention discloses a process for supporting computer infrastructure, integrating, hosting, maintaining, and deploying computer-readable code into the computer system 101, wherein the code in combination with the computer system 101 is capable of performing a method for enhancing a crowdsourced integrated development environment.

Any of the components of the present invention could be created, integrated, hosted, maintained, deployed, managed, serviced, supported, etc. by a service provider who offers to facilitate a method for enhancing a crowdsourced integrated development environment. Thus the present invention discloses a process for deploying or integrating computing infrastructure, comprising integrating computer-readable code into the computer system 101, wherein the code in combination with the computer system 101 is capable of performing a method for enhancing a crowdsourced integrated development environment.

One or more data storage units 111 (or one or more additional memory devices not shown in FIG. 1) may be used as a computer-readable hardware storage device having a computer-readable program embodied therein and/or having other data stored therein, wherein the computer-readable program comprises stored computer program code 107. Generally, a computer program product (or, alternatively, an article of manufacture) of computer system 101 may comprise the computer-readable hardware storage device.

While it is understood that program code 107 for enhancing a crowdsourced integrated development environment may be deployed by manually loading the program code 107 directly into client, server, and proxy computers (not shown) by loading the program code 107 into a computer-readable storage medium (e.g., computer data storage device 111), program code 107 may also be automatically or semi-automatically deployed into computer system 101 by sending program code 107 to a central server (e.g., computer system 101) or to a group of central servers. Program code 107 may then be downloaded into client computers (not shown) that will execute program code 107.

Alternatively, program code 107 may be sent directly to the client computer via e-mail. Program code 107 may then either be detached to a directory on the client computer or loaded into a directory on the client computer by an e-mail option that selects a program that detaches program code 107 into the directory.

Another alternative is to send program code 107 directly to a directory on the client computer hard drive. If proxy servers are configured, the process selects the proxy server code, determines on which computers to place the proxy servers' code, transmits the proxy server code, and then installs the proxy server code on the proxy computer. Program code 107 is then transmitted to the proxy server and stored on the proxy server.

In one embodiment, program code 107 for enhancing a crowdsourced integrated development environment data is integrated into a client, server and network environment by providing for program code 107 to coexist with software applications (not shown), operating systems (not shown) and network operating systems software (not shown) and then installing program code 107 on the clients and servers in the environment where program code 107 will function.

The first step of the aforementioned integration of code included in program code 107 is to identify any software on the clients and servers, including the network operating system (not shown), where program code 107 will be deployed that are required by program code 107 or that work in conjunction with program code 107. This identified software includes the network operating system, where the network operating system comprises software that enhances a basic operating system by adding networking features. Next, the software applications and version numbers are identified and compared to a list of software applications and correct version numbers that have been tested to work with program code 107. A software application that is missing or that does not match a correct version number is upgraded to the correct version.

A program instruction that passes parameters from program code 107 to a software application is checked to ensure that the instruction's parameter list matches a parameter list required by the program code 107. Conversely, a parameter passed by the software application to program code 107 is checked to ensure that the parameter matches a parameter required by program code 107. The client and server operating systems, including the network operating systems, are identified and compared to a list of operating systems, version numbers, and network software programs that have been tested to work with program code 107. An operating system, version number, or network software program that does not match an entry of the list of tested operating systems and version numbers is upgraded to the listed level on the client computers and upgraded to the listed level on the server computers.

After ensuring that the software, where program code 107 is to be deployed, is at a correct version level that has been tested to work with program code 107, the integration is completed by installing program code 107 on the clients and servers.

Embodiments of the present invention may be implemented as a method performed by a processor of a computer system, as a computer program product, as a computer system, or as a processor-performed process or service for supporting computer infrastructure.

FIG. 2 is a flow chart that illustrates steps of a method for enhancing a crowdsourced integrated development environment (or “IDE”) in accordance with embodiments of the present invention. FIG. 2 comprises steps 205-250.

Methods of FIG. 2 may be performed by a processor of a computer system running an integrated development environment (“IDE”) that has been enhanced to let a user request collaborative assistance from remote communities of online users without compromising the user's privacy or security. In some embodiments, methods of FIG. 2 may be run by a distinct processor that performs steps of FIG. 2 and that interacts with another processor or system that runs other components of the IDE.

In step 205, the processor accesses a set of novel annotations related to a software-design or coding problem that the IDE user wishes to solve. These annotations may be embedded in a block of source code, where that block embodies the software problem. The annotations may identify data and instructions that tell the processor how to solicit help from the online communities in a secure, anonymized manner. In some embodiments, the processor may generate these annotations and add the annotations to a user-created block of code. In such cases, the processor may generate the annotations in response to receiving user input or to reading stored configuration data or settings of the IDE system.

In other cases, the user may create some or all of the annotations and manually embed them in the block of source code, using code-editing or code-annotating facilities built into the IDE. The processor would then retrieve the user-created annotations from the code, rather than generating them.

In either case, one or more of the annotations may comprise information that the processor has culled from interactive exchanges with the IDE user, or they may comprise information that the processor has retrieved from a computer storage medium.

In some embodiments, the block of code may comprise “skeleton code,” a script, pseudo-code, or another code framework written, using standard IDE functions, to identify the software problem. Such framework code may comprise implementation-dependent elements like: a class stub, Javascript language, one or more test cases (as might be used during a test-driven or prototyping development effort), API calls, library calls, or system calls. In other cases, the block of code may comprise actual source code of a software project in development.

In all embodiments, the block of code will be annotated by standard features of the enhanced IDE. In some cases, these standard features may be enhanced by adding functionality to the IDE through the IDE's standard expansion capabilities. For example, if the IDE supports the addition of new functionality by means of adding an extension module or other type of add-on module, new types of annotations may be added to the IDE by extending the IDE with plug-in module. This method of implementation provides an advantage of allowing novel annotations of the present invention to be straightforwardly added to a user's existing IDE platform, and thus avoid forcing the user to abandon a familiar programming environment, lose access to custom-built libraries, macros, and other tools that might work with only the user's current platform, or purchase a license to a special version of the IDE.

Another advantage of the present invention is that add-on modules may be tailored to add whatever types of annotations are deemed to be beneficial to a particular user, IDE, operating platform, infrastructure, or business goal. Embodiments and examples described in this document describe a core set of annotation types that are likely to be beneficial in a great number of cases, but these embodiments and examples should not be construed to limit the present invention to only those types of annotations, nor should they be construed to require every embodiment to support all those types of annotations.

The processor may embed into the block of source code one or more novel “platform” annotations. A platform annotation might identify a platform from which user feedback will be solicited from candidate responders, or a platform from which candidate responders may respond Such platforms may include a proprietary inhouse network or a public or private online community, such as a social network, a social-media service, an online developer's community, or another type of extrinsic network.

Such platforms might include networks based on the Internet, an intranet, a cellular network, a local-area or metropolitan-area network, a virtual network, a cloud-computing environment or cloud-based service, or any other formal, informal, or loosely organized electronic community of users that might possess expertise in a field related to the software problem. In some embodiments, a platform annotation may identify one or more privately owned or maintained platforms that may be maintained at least in part as a means of providing collaborative or crowdsourced development support.

In some embodiments, a platform annotation may designate a platform to which a request for user feedback is posted or “advertised,” and in others, it may designate a platform from which responsive feedback may be accepted. In certain embodiments, both types of designations may be possible, and a single platform may be designated to serve both functions. In some cases, multiple platform annotations may identify different platforms or different sets of platforms, for solicitation and response functions.

Examples of platforms that exist at the time at which this document is filed include Twitter, LinkedIn, Facebook, Connections, Slack, HipChat, Git, and StackOverflow. Many other platforms may qualify, including those that do not yet exist at the time of filing. One advantage of the present invention is that it is flexible enough to accommodate almost any network of users capable of accommodating an automated interface to an external software application, such as the present invention's enhanced IDE, or a standard communications mechanism that may exchange information with the enhanced IDE.

The processor may embed one or more novel “text” annotations into the block of source. These annotations may comprise text describing the software problem. This problem may be related to one or more of a language syntax or semantics, a business or technical requirement, a resource constraint, a design of an algorithm, a documentation entity, a project-management consideration, or any other type of problem capable of arising during the course of a software-development effort.

Each text annotation may completely describe one such problem or a class of such problems, may completely describe multiple problems or multiple classes of problems, or may describe portions of one or more problems. Similarly, a set of text annotations may in aggregate completely describe one problem, multiple problems, or portions of one or more problems. In some embodiments, a text annotation may comprise a hyperlink, URL, network identifier, or other electronic reference to a more complete description of a problem.

A text annotation may comprise a block of freeform or natural-language text, and it may comprise one or more preset codes or keywords. In some embodiments, when displaying a problem description to candidate responders, the processor may transparently translate such codes or keywords into natural language that is understandable by a human being.

The processor may embed one or more novel “anonymous” annotations into the block of text that identify whether or how the code should be anonymized when viewed by candidate responders. In some embodiments, an anonymous annotation may be used for a related purpose, such as identifying whether portions of the code should be redacted to better protect privacy or security, whether the code should reveal the identity of the user requesting feedback, or whether the identities of one or more feedback-providing responders should be fully or partially anonymized on some or all of the platforms designated by one or more platform annotations. In cases where several levels of anonymization are possible, an anonymous annotation may designate which level of anonymization is appropriate for one or more platforms.

The processor may embed one or more novel “child-reference level” annotations into the block of text that identify how many levels of child reference calls to include in a context of the block of source code of a solicitation for feedback. If, for example, an annotated block of code calls a first child subroutine, which in turn calls a second child subroutine that then calls a function of a binary library, a child-reference level annotation that specifies three levels of child references would embed the first child subroutine, the second child subroutine, and the binary-library function into a context of a solicitation for feedback. If the child-reference level annotation instead specifies only two levels of child references, the processor would instead include only the first child subroutine and the second child subroutine in the context of the request for feedback.

Similarly, the processor may embed one or more novel “parent-reference level” annotations into the block of code that each identify how many levels of parent reference calls to include in the request for feedback. If, for example, the block of code is called by a first parent subroutine, which in turn was called by a parent application, a parent-reference level annotation that specifies two levels of parent references would result the processor including both levels of parent code in the context of the request for feedback.

At the conclusion of step 205, the processor will have received and processed a set of novel annotations of a block of source code, where the annotations were embedded into the block of code by a user of the IDE, by an automated function of the IDE, or by the processor itself. The block of code embodies a software-design or software-development problem for which the user hopes to solve by soliciting feedback from online communities through enhanced features of the IDE. These annotations will direct some or all of the processor's activities throughout the remaining steps of the method of FIG. 2.

As described above, the processor may annotate the block of source code in response to user interaction, allowing the user to interactively specify parameters that the processor translates into specific types of parameterized annotations. In other embodiments, the processor may embed some or all of the annotations automatically by reading information from a predefined file that specifies, for example, default values of a “platform” parameter or an anonymous “parameter.” One advantage of the current invention is that it is flexible enough to accommodate any type of known data-identifications mechanism from which the processor may identify information it needs in order to generate or receive annotations.

Another advantage of the current invention is that, by adding annotation functionality to an IDE by means of a standardized plug-in or extension, the new types of annotations may be easily formatted to comply with conventions of the IDE. If, for example, an IDE's existing annotation conventions require annotations to be delimited by “@@” strings, embodiments of the present invention may easily conform to this convention by means of a plug-in module that automatically adds such delimiters to each novel annotation implemented by the plug-in.

In step 210, the system gathers information from which may be identified or inferred a context for a solicitation or request for feedback. The system organizes the information gathered in this step into a body of data referred to here as a “context” of the annotated source code or of the solicitation for feedback.

The system selects the information to be gathered in this step as a function of information contained in the annotations. If, for example, a child-reference level annotation identifies that three nested levels of child references should be disclosed to online users that respond to the solicitation for feedback, the processor will include in the context one or more child blocks of source code identified by child references, to a depth of three levels of nesting. In some embodiments, the processor in this step may include only references to the one or more child blocks of code. In either case, the child blocks will be included in a distribution bundle created in step 215 and communicated to candidate responders in step 240.

The system in this step may further customize the context of the annotated block of source code as a function of other annotations. If, for example, the annotated block of source code comprises a “parent-reference level” annotation that identifies three levels of parent references to the annotated block, then the processor in step 210 will add to the context blocks of “parent” code, comprising software modules, down to three nested levels, that make calls to the annotated block.

Similarly, the processor in this step may embed into the context one or more textual problem descriptions identified by one or more text annotations. If the processor identified an anonymous annotation in step 205, the processor may add to the context instructions for performing the anonymization functions specified by the anonymous annotation. In some cases, no anonymization instructions will be added to the context, and the processor will instead in step 215 perform anonymization functions specified by the anonymous annotation when building the distribution bundle.

In step 215, the processor builds the distribution bundle that may be forwarded to candidate responders that respond to the solicitation by returning a request to view block of source code and its context. The exact contents and format of this bundle are implementation-dependent, and may be selected by a person skilled in the art who has expert knowledge of the communications protocols and infrastructure connecting the user with the responders, of the enhanced IDE and the platform on which it runs, or of formatting or communications requirements of the platforms to which the bundle must be communicated.

In all cases, the bundle will include at least the annotated block of source code and all or part of the context of the source code assembled in step 210. As described above, this context may include parent or child blocks of source code, a textual statement of the software problem, and other metadata and additional information specified by the annotations.

In some embodiments, the context may further include instructions to the processor that direct the processor how to prepare the distribution bundle. These instructions may be removed by the processor before communicating the distribution bundle to candidate responders.

The processor in this step may, for example, read anonymization instructions embedded into the context block in step 210 in response to an identification of an anonymous annotation. As described above, this anonymization procedure may comprise functions like removing data that identifies the IDE user, or redacting portions of the block of source code or the context to hide sensitive data.

The processor may in this step further reformat certain elements of the annotated source code block or of the context. The processor may, for example, format a textual statement of the software problem so that it is displayed to a candidate responder in a particular font or with a particular type of page layout. The processor in this step may also strip the annotations from the copy of the block of code or the context that will be included in the distribution bundle.

In step 220, the processor posts a solicitation for feedback. This solicitation is an electronic communication posted to platforms specified by the one or more platform annotations, and it requests feedback that may aid the IDE user in solving the software problem. In various embodiments, the IDE user, or constraints imposed by technical, business, security, or privacy concerns, may determine how much descriptive detail is identified by the solicitation. The one or more anonymous annotations may further determine a method or degree of anonymization applied by the processor to the solicitation.

In some embodiments, the solicitation may comprise a software linkage that links the IDE platform to the online platform to which the solicitation is sent. In such cases, a candidate responder, or other user, of the platform to which the solicitation is posted, may use such a linkage to access a resource related to the solicitation, such as a section of shared source code or a selected element of data under control of the IDE.

In some embodiments, the solicitation may include the annotated block of source code (with or without some or all of its embedded annotations), or it may include textual descriptions of the software problem identified by the one or more text annotations. In other cases, the solicitation might instead include a software linkage that merely refers a candidate responder to a block of source code or other data item stored on the IDE's local platform. This latter method offers an advantage of allowing the system to control which elements of the source code are visible to particular candidate responders. In an embodiment that, for example, allows the processor to identify platforms or candidate responders with whom the IDE user has established a trusted relationship, the processor might generate targeted solicitations that reveal more information to trusted recipients.

In embodiments that allow limited or no identification of candidate responders, the processor might make a similar anonymization decisions based on characteristics of the responder or of the platform from which the responder replies. In one example, the processor might communicate a solicitation to the Twitter platform that allows previously unknown Twitter users to link only to a redacted block of source code and a limited text description of the software problem. But if the processor receives a response to a solicitation posted on a professional social network hosted by the IDE user's company, the processor might allow the responding user to link to a more complete block of code or to a textual description of the software problem that references proprietary business applications. The processor might allow this greater access to the second user because of the user's platform or because of some other known or inferred characteristic of the user, even if the user is not personally identified.

The processor may further determine which information should be revealed to a candidate responder as a function of other known characteristics of that user, such as whether that user: has been previously identified as possessing expertise or interest in a technical field or project related to the block of code or to the software problem embodied in the block of code; has in the past raised questions about software problems similar to the IDE user's software problem; or has in the past provided useful feedback to a certain number of solicitations or to a certain number of solicitations that comprised programming languages, platforms, general classes of problems, or other elements similar to those of the current solicitation.

Certain embodiments may not limit a solicitation to a combination of text and linkages and may instead display the entire distribution package available to candidate responders. In other cases, the processor may make the entire distribution package visible, or transmit all or part of the distribution package, only to those candidates that express interest by replying to the solicitation.

The exact details of the methods of soliciting and of accepting a response to the soliciting may be implementation-dependent, and may be determined by a person skilled in the art as functions of the communications, privacy, and security features offered by the IDE user's local platform or offered by one or more of the platforms specified by the platform annotations. In all cases, however, the processor will electronically communicate to users of online platforms or communities specified by the annotations a solicitation for assistance solving a software problem; and, in response to receiving a reply from a receiver of that solicitation, communicate to that receiver further information about the software problem if any further information is deemed necessary in order for the receiver to solve the problem.

In step 225, the processor receives one or more responses to the solicitation, where each of the one or more responses comprises a request to view the problematic block of source code, or comprises a request for more information about the software problem. In embodiments where the solicitation comprises the distribution, and where the distribution package is thus already visible to candidate responders, the processor may receive in this step, if necessary, communications from candidate responders that identify their interest in providing feedback.

In step 230, the processor makes the distribution bundle visible to the responding users if it is not already fully visible. This step may be performed by any means known in the art, such as by allowing a responding user to link to a copy of the block of source code stored locally to the IDE or within the IDE itself, or by transmitting the distribution bundle through a secured or unsecured, public or private, communications network.

The distribution bundle may be formatted and communicated in a way that allows the bundle to be displayed by the platform that receives the bundle in a native format or an otherwise-supported format of that platform. In some cases, if a platform comprises a general-purpose user interface like a Web browser, the distribution bundle may be formatted into a language, such as HTML or JavaScript, that allows the bundle to be displayed correctly through the platform's interface. This may be true regardless of whether a physical copy of the bundle is sent to the platform's user or whether the user links to an instance of the bundle that is stored locally to the IDE. In many embodiments, the contents of this file may be represented by means of appropriate formatting, such as by highlighting text, by selecting font and paragraph characteristics of text elements, or by displaying textual, graphical, or multimedia information related to an annotation. If the distribution bundle comprises a data structure or logical structure, such as a set of parent-child modules or an array of data elements, the distribution bundle may be further formatted to graphically display some or all of the information comprised by the bundle.

The distribution bundle may in some cases be distributed as a compressed archive file, such as a .ZIP, .RAR, or .TAR file, and this file may be password-protected, encrypted, or otherwise secured by means known in the art.

In step 235, the processor receives feedback in response to the solicitation from a responder to whom the solicitation had been communicated in step 220 or who had received the distribution bundle, or other related information, in step 230.

This feedback may take any form that is deemed appropriate to the IDE user, to a platform on which the IDE runs or on which the user works, to the responding user, to the responding user's platform, to the communications infrastructure through which the feedback is communicated, or to other implementation-dependent factors. If, for example, the feedback is communicated as a low-bandwidth SMS message through a cellular network, it might be formatted as simple text. But if passed through a high-speed intranet backbone, it might be formatted so as to accommodate graphical or video content or executable computer instructions. If an IDE platform requires incoming textual data to conform to a certain text format, such as a specified string delimiter or maximum string length, then the processor may translate a textual feedback communication into a conformant format prior to forwarding the communication to an IDE module, or other software entity, that displays the feedback to the user. Selection of the exact format of the feedback may be determined by a person skilled in the field.

The feedback may be communicated to the processor by any means deemed appropriate. For example, the responder may submit the feedback directly to the responder's social-media platform or communications network, which then, through the platform or network's intrinsic functionality, forward the feedback to the processor or notifies the processor that feedback is available.

In other cases, the responder may submit the feedback by means of a linkage embedded in the solicitation or in the distribution bundle. In yet other instances, the responder may submit the feedback by sending it directly to an email address, a Web URL, a phone number, or to another type of identifier or address selected by the solicitation or by the distribution bundle.

The feedback may comprise content that is determined by the IDE user, by the processor, by a computer system that comprises the processor, or by the responding user. In some embodiments, the feedback may, for example, include a revised version of the original annotated block of source code or a version of the original annotated block to which have been added an embedded set of annotations that describe the responder's recommended solution.

In step 240, the processor may filter incoming feedback such that feedback from certain platforms or certain types of users is modified or deleted prior to being communicated to the IDE user. This modification or deletion may be performed for any reason deemed to be significant to the IDE user or to the IDE user's business.

In step 245, the processor may analyze the received feedback before forwarding it to the IDE user. This analyzing may comprise any operation deemed appropriate by the system designers, such as checking the feedback for inappropriate terminology or validating the feedback as a true attempt to address the software problem.

In some embodiments, the analyzing may comprise an attempt to identify a similarity between the current feedback and previously provided feedback. If, for example, the processor identifies similar patterns or other congruencies in the current and previous feedback communications, that identification may result in the processor characterizing the feedback as having a greater or lesser likelihood to comprise a satisfactory solution to the software problem.

The processor in this step may similarly compare the received feedback with known solutions to previously identified problems, where those problems were similar in some way to the current software problem. In such cases, if the received feedback sufficiently matches historic solutions in a predetermined way, such as by means of known methods of code profiling or static analysis, then the processor might respond by increasing a confidence level in the received feedback. This analysis may also be used for other purposes, if desired, such as to identify historic problem solutions that may be combined with the current feedback in order to provide a more comprehensive or effective solution to the current software problem.

In step 250, the processor delivers one or more received feedback communications to the IDE user. The processor may deliver these communications and notify the user of their availability through any means known in the art. The processor may, for example, display the feedback by means of the IDE's standard user interface, notify the user by extrinsic means, such as by email or by a push notification, or may allow the user to view the feedback from within a social-media service or other platform from which the responder submitted the feedback or to which the solicitation or distribution bundle was sent in step 220 or 225.

In some cases, the processor may display multiple feedback communications submitted by multiple responders. These multiple communications may be displayed with indicators of confidence levels or other indicators that identify relative likelihoods that each communication is effective, relevant to the software problem, or otherwise useful to the IDE user.

Multiple feedback communications may be displayed in an order determined by the communications' relative ranking as a function of confidence levels of each communication, by the platforms or users from which they were received, by a determination made as a basis of historic data in step 245, by the existence of trust relationships with certain submitting users, or by other criteria.

Details of the manner in which the processor displays the received communications may be based on a configuration setting of the IDE, on a communication from the IDE user, or on a characteristic of the IDE environment, of a responding user, or of remote platform related to the solicitation or the remote user.

In a simple example of the method of FIG. 2, an IDE user developing source code in the Java programming language encounters a software-design problem when she discovers that she does not know how to concatenate two string variables in Java.

Using the IDE's native code-creation and annotation features, the user creates a block of source code that embodies this problem and embeds an “@collaborate” annotation into the block of code. This annotation alerts the IDE that the block of code should be treated as a request for feedback from users at one or more online communities. The user further inserts other annotations that will be used by the enhanced IDE to perform steps of a method in accordance with embodiments of the present invention.

In this example, the annotated block of code may take the form:

```
//@collaborate (platform=StackOverflow,
  // text=″What is the best way to concat two strings in Java?″
  anonymous=false)
private String myMethod( ){
  String toreturn = ″Hello″ + ″ World″;
  return toreturn;
}
```

Here, the @collaborate annotation comprises the novel annotations as parameters, but embodiments may comprise annotations in other formats that conform to conventions specific to a particular programming language or IDE.

In this example, a platform annotation specifies that feedback should be solicited in a programmer's social-media community known as StackOverflow. The software problem is defined by the text annotation as: “What is the best way to concat two strings in Java?”. The anonymous annotation specifies that the processor need not anonymize the solicitation for feedback.

The remainder of the annotated block of code comprises Java code that embodies a coded example of the problem. In this example, the IDE user does not require other annotations that might, for example, specify including additional levels of parent or child references.

In response to detecting the user's annotations, the processor, by means of the enhanced functionality of the IDE (which may be implemented as a plug-in module or add-on extension to the IDE) generates a solicitation and posts the solicitation to the StackOverflow.com Web site. This solicitation includes the textual problem description and the Java-coded example. In other cases, the solicitation might not include the full block of source code, requiring interested StackOverflow users to click a link in the solicitation or otherwise return a communication to the IDE that indicates an interest in responding to the solicitation.

The system receives several responses from StackOverflow users. The processor might alert the IDE user that responses have arrived by sending an SMS text message to the IDE user's cell phone, by sending the IDE user an email message, or by displaying a notification by means of the IDE's user interface.

In one example, the processor might modify the annotated block of source code within the IDE to include a new annotation:

// @answers=2, hover to view

This annotation, appearing in the IDE's integrated workspace, would allow the IDE user to hover a cursor over the annotated block in order to display one or more received feedback communications in a pop-up window. In some cases, the processor might have ordered or ranked the responses, by comparing the responses to historical data, or as a function of a known characteristic of the responding users. In such cases, processor might display multiple feedback communications in order of ranking, or the processor might display only the first or first few, most highly ranked, communications.

One manner of displaying a feedback communication might comprise a form:

```
//@collaborate (platform=StackOverflow,
  // text=″What is the best way to concat two strings in Java?″
  anonymous=false)
// @answer = showing most voted/popular answer
// @answer_justification = StringBuilder is not synchronized and it's rare
  that you'd need synchronization
private String myMethod( ){
  StringBuilder toreturn = new StringBuilder(″Hello″);
    toreturn.append(″ World″);
return toreturn.toString( );
}
```

Here, the existence of feedback is identified by a first “@answer” annotation that is formatted in a manner that conforms with formal conventions of the IDE. A second @answer annotation identifies that a particular problem solution is displayed because it was returned in feedback received from a greatest number of responders. The solution is shown as a revised version of the original block of source code that illustrates a way to code a solution to the software problem.

In some embodiments, the enhanced IDE might then allow the user to display other, perhaps less reliable, feedback communications by clicking a button on the IDE interface, pressing a keyboard key, or performing another known type of user action.

The processor might then continue to update the list of feedback communications displayed to the IDE user as more feedback communications arrive. If the processor performs filtering or analytical operations upon each received feedback communication, the order and ranking of the displayed communications may change.

The claims are as follows:

1. A module of an interactive development system comprising a processor, a memory coupled to the processor, and a computer-readable hardware storage device coupled to the processor, the storage device containing program code configured to be run by the processor via the memory to implement a method for enhancing a crowdsourced integrated development environment, the method comprising:
identifying annotated computer source code from a user of the integrated development environment, where the annotated computer source code comprises embedded social-code annotations that identify information to facilitate solving a software-development problem of the annotated computer source code that the user wishes to solve;
retrieving the social-code annotations embedded into the source code;
capturing a context of the annotated computer source code as a function of the retrieved social-code annotations;
generating a distribution bundle that comprises the annotated computer source code and at least part of the captured context, wherein the contents of the distribution bundle are selected as a function of the captured context;
soliciting feedback from an online community, where the online community is identified by the retrieved social-code annotations;
receiving a response from a responding party of the online community, where the response indicates that the responding party is willing to provide feedback;
making the distribution bundle available to the responding party;
accepting feedback returned by the responding party; and
directing the integrated development environment to communicate the feedback to the user.

2. The system of claim 1, where the retrieved social-code annotations comprise a description of the software-design problem.

3. The system of claim 1, where the retrieved social-code annotations identify whether the user should be identified to the responding party.

4. The system of claim 1, where the retrieved social-code annotations identify whether the annotated source code should be redacted.

5. The system of claim 1,
where the captured context identifies nested levels of parent software objects,
where each software object of the parent software objects directly or indirectly calls a component of the annotated computer source code,
where the generating further comprises adding at least one level of the nested levels of parent software objects to the distribution bundle, and
where the retrieved social-code annotations identify a maximum number of nested levels of the parent software objects capable of being added to the distribution bundle.

6. The system of claim 1,
where the captured context identifies nested levels of child software objects,
where each software object of the child software objects is directly or indirectly called by a component of the annotated computer source code,
where the generating further comprises adding at least one level of the nested levels of child software objects to the distribution bundle, and
where the retrieved social-code annotations identify a maximum number of nested levels of the child software objects capable of being added to the distribution bundle.

7. The system of claim 1, where the annotated computer source code is related to a particular class of software application and where the feedback is accepted from the responding party because the responding party is known to have previously expressed interest in the particular class of software application.

8. The system of claim 1, where the feedback is accepted from the responding party because the responding party shares a trust relationship with the user.

9. The system of claim 2, where the feedback is accepted from the responding party because the responding party is known to possess expertise related to the software-design problem.

10. The system of claim 2, where the feedback comprises a revision to the annotated computer source code code that is intended by the responding party to solve the software-design problem.

11. The system of claim 1, where the forwarding comprises one or more actions selected from a group consisting of:
displaying all or part of the feedback to the user through a user interface of the integrated development environment,
notifying the user through a computerized communications medium distinct from the integrated development environment, and
enabling the user to view the feedback from within the online community.

12. The system of claim 2, further comprising:
receiving a second response from a second responding party of the online community, where the second response indicates that the second responding party desires to provide feedback;
making the distribution bundle available to the second responding party; and
accepting a second feedback returned by the second responding party, where the two responding parties do not collaborate with each other in helping to solve the software-design problem.

13. The system of claim 12, further comprising:
ranking the two accepted feedbacks to indicate which of the two accepted feedbacks is more likely to identify a correct solution to the software-design problem; and
displaying the two accepted feedbacks in a manner that indicates relative likelihoods of each feedback to identify a correct solution to the software-design problem.

14. The system of claim 2, further comprising:
determining whether the feedback is appropriate before making the feedback available to the user by comparing the feedback to known-good solutions to previous programming problems, where the previous programming problems are in a same category of software problems as the software-design problem; and
displaying the feedback to the user after determining that the feedback is appropriate.

15. A method for enhancing a crowdsourced integrated development environment system, the method comprising:
identifying, by the system, annotated computer source code from a user of the integrated development environment,
where the annotated computer source code comprises embedded social-code annotations that identify:
information to facilitate solving a software-development problem of the annotated computer source code that the user wishes to solve,
a description of a software-design problem that the user wishes to solve,
whether the identity of the user should be anonymized, and
whether the annotated source code should be redacted;
retrieving, by the system, the social-code annotations embedded into the source code;
capturing, by the system, a context of the annotated computer source code as a function of the retrieved social-code annotations;
generating, by the system, a distribution bundle that comprises the annotated computer source code and at least part of the captured context, wherein the contents of the distribution bundle are selected as a function of the captured context;
soliciting, by the system, feedback from an online community, where the online community is identified by the retrieved annotations;
receiving, by the system, a response from a responding party of the online community, where the response indicates that the responding party is willing to provide feedback;
making available, by the system, the distribution bundle to the responding party;
accepting, by the system, feedback returned by the responding party; and
forwarding, by the system, the feedback to the user.

16. The method of claim 15,
where the captured context identifies nested levels of parent software objects,
where each software object of the parent software objects directly or indirectly calls a component of the annotated computer source code,
where the generating further comprises adding at least one level of the nested levels of parent software objects to the distribution bundle, and
where the retrieved social-code annotations identify a maximum number of nested levels of the parent software objects capable of being added to the distribution bundle.

17. The method of claim 15,
where the captured context identifies nested levels of child software objects,
where each software object of the child software objects is directly or indirectly called by a component of the annotated computer source code,
where the generating further comprises adding at least one level of the nested levels of child software objects to the distribution bundle, and
where the retrieved social-code annotations identify a maximum number of nested levels of the child software objects capable of being added to the distribution bundle.

18. The method of claim 15, further comprising:
receiving a second response from a second responding party of the online community, where the second response indicates that the second responding party desires to provide feedback;
making the distribution bundle available to the second responding party; and
accepting a second feedback returned by the second responding party, where the two responding parties do not collaborate with each other in helping to solve the software-design problem.

19. The method of claim 18, further comprising:
ranking the two accepted feedbacks to indicate which of the two accepted feedbacks is more likely to identify a correct solution to the software-design problem; and
displaying the two accepted feedbacks in a manner that indicates relative likelihoods of each feedback to identify a correct solution to the software-design problem.

20. The method of claim 15, further comprising:
determining whether the feedback is appropriate before making the feedback available to the user by comparing the feedback to known-good solutions to previous programming problems, where the previous programming problems are in a same category of software problems as the software-design problem; and
displaying the feedback to the user after determining that the feedback is appropriate.

21. The method of claim 15, further comprising providing at least one support service for at least one of creating, integrating, hosting, maintaining, and deploying computer-readable program code in the computer system, wherein the computer-readable program code in combination with the computer system is configured to implement the identifying, the retrieving, the capturing, the generating, the soliciting, the receiving, the making available, the accepting, and the forwarding.

22. A computer program product, comprising a computer-readable hardware storage device having a computer-readable program code stored therein, the program code configured to be executed by an interactive development system comprising a processor, a memory coupled to the processor, and a computer-readable hardware storage device coupled to the processor, the storage device containing program code configured to be run by the processor via the memory to implement a method for enhancing a crowdsourced integrated development environment system, the method comprising:
identifying, by the system, annotated computer source code from a user of the integrated development environment,
where the annotated computer source code comprises embedded social-code annotations that identify:
information to facilitate solving a software-development problem of the annotated computer source code that the user wishes to solve,
a description of a software-design problem that the user wishes to solve,
whether the identity of the user should be anonymized, and
whether the annotated source code should be redacted;
retrieving, by the system, the social-code annotations embedded into the source code;
capturing, by the system, a context of the annotated computer source code as a function of the retrieved social-code annotations;
generating, by the system, a distribution bundle that comprises the annotated computer source code and at least part of the captured context, wherein the contents of the distribution bundle are selected as a function of the captured context;
soliciting, by the system, feedback from an online community, where the online community is identified by the retrieved annotations;
receiving, by the system, a response from a responding party of the online community, where the response indicates that the responding party is willing to provide feedback;
making available, by the system, the distribution bundle to the responding party;
accepting, by the system, feedback returned by the responding party; and
forwarding, by the system, the feedback to the user.

23. The computer program product of claim 22,
where the captured context identifies nested levels of parent software objects,
where each software object of the parent software objects directly or indirectly calls a component of the annotated computer source code,
where the generating further comprises adding at least one level of the nested levels of parent software objects to the distribution bundle, and
where the retrieved social-code annotations identify a maximum number of nested levels of the parent software objects capable of being added to the distribution bundle.

24. The computer program product of claim 22,
where the captured context identifies nested levels of child software objects,
where each software object of the child software objects is directly or indirectly called by a component of the annotated computer source code,
where the generating further comprises adding at least one level of the nested levels of child software objects to the distribution bundle, and
where the retrieved social-code annotations identify a maximum number of nested levels of the child software objects capable of being added to the distribution bundle.

25. The computer program product of claim 22, further comprising:
receiving a second response from a second responding party of the online community, where the second response indicates that the second responding party desires to provide feedback;
making the distribution bundle available to the second responding party;
accepting a second feedback returned by the second responding party, where the two responding parties do not collaborate with each other in helping to solve the software-design problem;
ranking the two accepted feedbacks to indicate which of the two accepted feedbacks is more likely to identify a correct solution to the software-design problem; and
displaying the two accepted feedbacks in a manner that indicates relative likelihoods of each feedback to identify a correct solution to the software-design problem.
